(19) United States
(12) Patent Application Publication
(10) Pub. No.: US 2010/0173585 A1
(43) Pub. Date: Jul. 8, 2010

(54) SEAMLESS DATA COMMUNICATION EXPERIENCE

(75) Inventors: Candace J. Button, Woodinville, WA (US); Robert Warren Gruen, Kirkland, WA (US); Richard Lloyd Hughes, Monroe, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/350,241

(22) Filed: Jan. 8, 2009

(51) Int. Cl. H04B 7/00

(52) U.S. Cl. 455/41.3

(57) ABSTRACT

A method of providing a seamless data communication experience across a presence aware device and an additional presence aware device is disclosed. A data communication experience may be transferred from a presence aware device to an additional presence aware device when a user selects to switch to an additional presence aware device or leaves the presence of the presence aware device.

### BACKGROUND

This Background is intended to provide the basic context of this patent application and it is not intended to describe a specific problem to be solved.

Data communication, such as listening to music, watching a video, playing a video game, downloading data, etc., may occur on a variety of devices. Users of the devices may move from location to location, but often, the data communication experience is tied to a specific device. If the device is portable, such as a portable media player, the data communication experience may follow the user. However, using a portable media device inside a house that has an elaborate sound system may not make sense. In addition, wearing headphones from a portable media player in a car may be illegal in some states and countries. It would make more sense to have the data communication experience be handed off from relevant device to relevant device as a user moves through daily life.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method of providing a seamless data communication experience across a presence aware device and an additional presence aware device is disclosed. In one embodiment, the method may determine if a beacon signal has been received, either by a presence aware device or an additional presence aware device and, if the beacon signal is recognized, communication may be established between the presence aware device and the additional presence aware device. The method may also review on the additional presence aware device the beacon signal for a status indication of the data communication experience from the presence aware device. If a status indication is present, the status indication of the data communication experience may be stored on the additional presence aware device. The method may determine if the beacon signal indicates that the data communication experience has been selected to end on the presence aware device. If yes, the method may determine if the additional presence aware device is data communication experience capable. If yes, the data communication experience may be executed on the additional presence aware device using the status indication and the method may repeat by substituting the additional presence aware device for the presence aware device. If the additional presence aware device is not data communication experience capable, the method may repeat by substituting the additional presence aware device for the presence aware device.

### BRIEF DESCRIPTION OF THE DRAWINGS

FIG. 1 is an illustration of a portable computing device;

FIG. 2 is an illustration of a presence aware device communicating a beacon signal related to a data communication experience to an additional presence aware device;

FIG. 3 is an illustration of a presence aware device communicating a beacon signal related to a data communication experience to an additional presence aware device; and

FIG. 4 is an illustration of a method of providing a seamless data communication experience across a presence aware device and an additional presence aware device.

### SPECIFICATION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

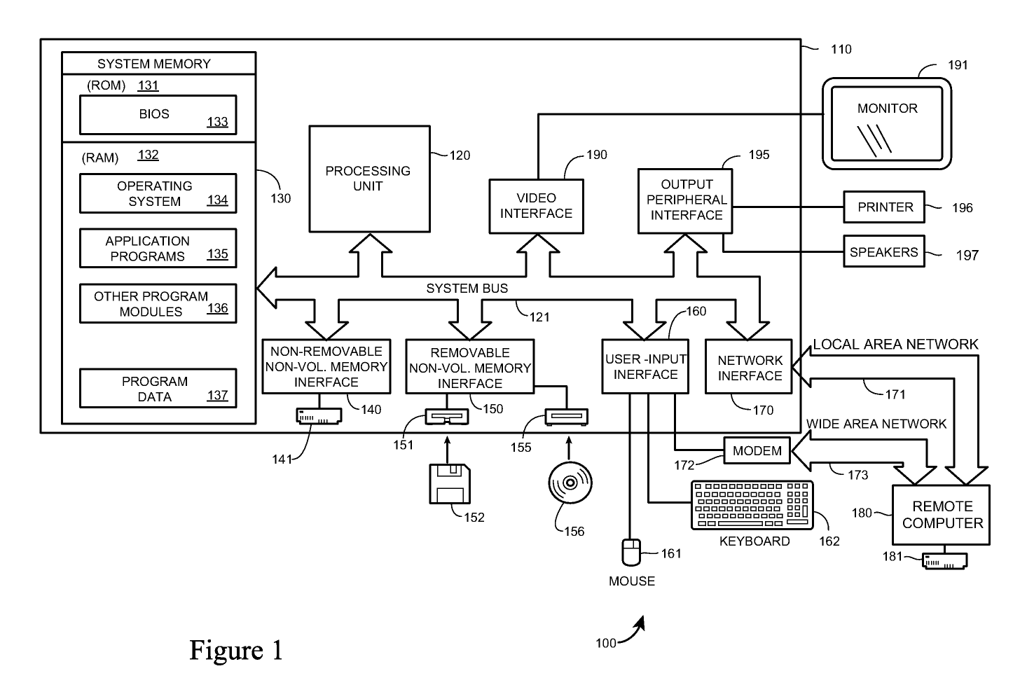

FIG. 1 illustrates an example of a suitable computing system environment 100 that may operate to execute the many embodiments of a method and system described by this specification. It should be noted that the computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100.

With reference to FIG. 1, an exemplary system for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120.

The computer 110 may operate in a networked environment using logical connections to one or more remote computers, such as a remote computer 180, via a local area network (LAN) 171 and/or a wide area network (WAN) 173 via a modem 172 or other network interface 170.

Computer 110 typically includes a variety of computer readable media that may be any available media that may be accessed by computer 110 and includes both volatile and nonvolatile media, removable and non-removable media. The system memory 130 includes computer storage media in the form of volatile and/or nonvolatile memory such as read only memory (ROM) 131 and random access memory (RAM) 132. The ROM may include a basic input/output system 133 (BIOS). RAM 132 typically contains data and/or program modules that include operating system 134, application programs 135, other program modules 136, and program data 137. The computer 110 may also include other removable/non-removable, volatile/nonvolatile computer storage media such as a hard disk drive 141 a magnetic disk drive 151 that reads from or writes to a magnetic disk 152, and an optical disk drive 155 that reads from or writes to an optical disk 156. The hard disk drive 141, 151, and 155 may interface with system bus 121 via interfaces 140, 150.

A user may enter commands and information into the computer 20 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device may also be connected to the system bus 121 via an interface, such as a video interface 190. In addition to the monitor, computers may also include other peripheral output devices such as speakers 197 and printer 196, which may be connected through an output peripheral interface 190.

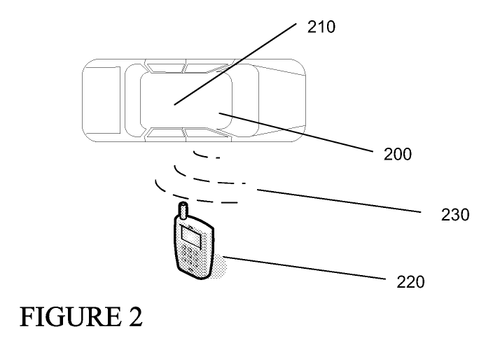

Referring to FIG. 2, a presence aware device 200 and/or additional presence aware device 220 may contain a processor 120 for executing computer executable instructions, a memory 140 150 for storing computer executable instructions and an input/output circuit such as the network interface 170 and may be one like that described in FIG. 1. The presence aware device 200 and/or the additional presence aware device 220 may be in a variety of commonly known forms such as, for example and not limitation, a portable media player, a cell phone, an electronic personal assistant, a personal computer, a portable media player that is based in a car, a home stereo system, etc. Accordingly, the data communication experience 210 may encompass many different experiences, for example and not limitation, an audio experience, a video experience, a game experience, an audio/visual experience, an internet experience (viewing a web site, playing an internet based game, etc.) or a download experience depending on the device and desired experience.

In most situations, the data communication experience 210 will be occurring. The data communication experience 210 may be selected by a user, such as a user selecting to play a song or to play a particular game. In some embodiments, the data communication experience 210 may have ended on the presence aware device 200 but may continue on the additional presence aware device 220 such as when a satellite radio station signal is lost in a parking garage but may be continued when the signal is received again at the additional presence aware device 220 such as when a portable media player is the additional presence aware device 220 and the portable media player is carried to an area with satellite reception.

In another aspect, the presence aware device 200 or additional presence aware device 220 may switch data deliver methods if one data delivery method is stopped in order to continue the data communication experience 220. For example, a car radio (presence aware device 200) is using a satellite signal as the data delivery method for music and the satellite signal is lost, the car radio (presence aware device 200) may attempt to obtain the music via other data delivery methods, such as using an FM receiver in the car radio (presence aware device 200), a wifi receiver, a cellular receiver, etc. The priority of different data delivery methods may have a default value and/or may be adjusted by a user.

In operation, the method of providing a seamless data communication experience across the presence aware device 200 and the additional presence aware device 220 may allow a user to begin the data communication experience 210 using the presence aware device 200 and when the user leaves the area of the presence aware device 200 (or the presence aware device 200 is switched off or disabled), the experience may continue on the additional presence aware device 220 that is in the area of the user. In another embodiment, the user may carry an electronic device with an electronic memory that holds the beacon signal 230 that is used to execute the data communication experience 210 once the additional presence aware device 220 is encountered.

In a real life example, the method may allow a user to play music (the data communication experience 210) on a car stereo (the presence aware device 200) and when the car and car stereo are turned off, the music (the data communication experience 210) may begin on the user's portable media player (the additional presence aware device 220) that is in the car, using the beacon signal 230 or a status indication 240 to continue playing the music (the data communication experience 210) at a similar point and volume as was in the car. In addition, the data communication experience 210 may begin at a slightly different point, such as a few second back for the user to “re-acquire” the data communication experience 210. In addition, a user may be able to adjust the starting point of the data communication experience 210 based on the user's preferences or the physical elements that are involved.

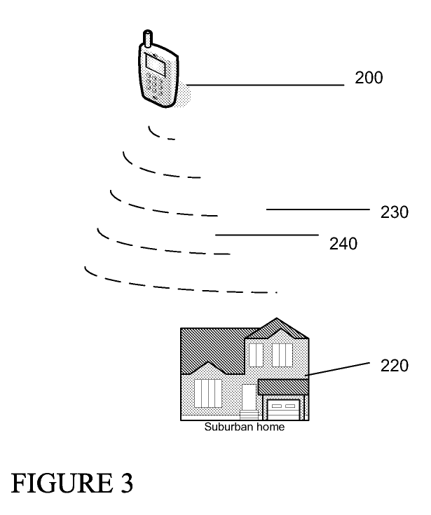

Referring to FIG. 3, in another real life example, a multimedia cellular telephone (the presence aware device 200) may be playing music (the data communication experience 210) and when the multimedia cellular telephone (the presence aware device 200) is carried into a suburban house, the stereo (the additional presence aware device 220) in the house may begin playing the music (the data communication experience 210) at a similar point and volume as was on the multimedia cellular telephone (the presence aware device 200) by using the status indication.

Of course, additional arrangements are possible such as when a car with a car stereo (the presence aware device 200) that is playing music (the data communication experience 210) pulls into a home garage and the stereo system (the additional presence aware device 220) in the home begins to play the music (the data communication experience 210) at a similar point and volume as was on the car stereo (the presence aware device 200).

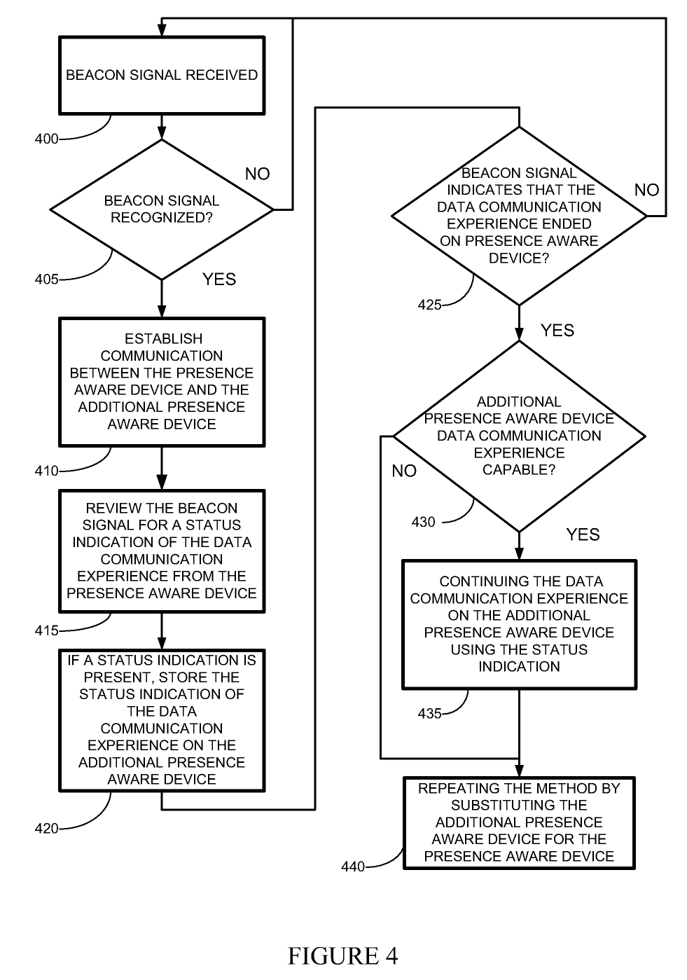

FIG. 4 illustrates an example of a method of providing a seamless data communication experience across the presence aware device 200 and the additional presence aware device 220. At block 400, on the additional presence aware device 220, it may be determined if the beacon signal 230 has been received from the presence aware device 200. The beacon signal 230 may be a signal that is communicated wirelessly, such as using Bluetooth technology or using wifi or publically available spectrum such as the 900 MHz spectrum. The communication may also be wired such as when a portable media player is connected through a wire to a car stereo. The beacon signal 230 may contain identification information such that the additional presence aware devices 220 may be able to recognize the presence aware device 200 or vice versa. The beacon signal 230 may also contain additional information, such as status indication 240 related to the data communication experience 210.

In one embodiment, the additional presence aware device 220 may periodically search for the beacon signal 230 from the presence aware device 200. In another embodiment, the presence aware device 200 may periodically communicate the beacon signal 230. In yet another embodiment, the presence aware device 200 may periodically search for the beacon signal from the additional presence aware device 220. And, in yet another embodiment, the additional presence aware device 220 may periodically communicate the beacon signal 230. In some embodiments, the presence aware device 200 and the additional presence aware device 220 may both communicate the beacon signal 230 and periodically search for beacon signals 230. In yet another embodiment, the receiving device (presence aware device 200 or additional presence aware device 220) enters a waiting loop for a beacon signal 230, meaning the receiving device (presence aware device 200 or additional presence aware device 220) looks virtually continuously for a beacon signal 230 rather than polling at given time intervals.

At block 405, a determination may be made whether the beacon signal 230 is recognized. The recognition may occur in a variety of ways. In one example, the presence aware device 200 and the additional presence aware device 220 are “paired” or introduced as being trusted previously such as with Bluetooth devices. The pairing may occur in any known way, or in another embodiment, the devices may exchange secure keys and use a hash algorithm to establish trust. In another example, the beacon signal 230 may contain data that is displayed on the receiving presence aware device 200 or the additional presence aware device 220 allowing the receiver to select to accept the beacon signal 230 as being recognized. As more and more devices become capable of sending, receiving or otherwise responding to beacon signals, the necessity to have a prearranged handoff may increase. Of course, other methods of establishing recognition are possible and are contemplated. If the beacon signal 230 is not recognized, control passes back to block 400. If the beacon signal 230 is recognized, control passes to block 410.

At block 410, if the beacon signal 230 is recognized as being acceptable, communication may be established between the presence aware device 200 and the additional presence aware device 220. Again, as mentioned previously, the beacon signal 230 may come from the presence aware device 200 or from the additional presence aware device 220. Similarly, the beacon signal 230 may be received by the presence aware device 200 or by the additional presence aware device 220.

The format of the communication may take on any logical format. For example, if the communication is wireless, the communication may use a Bluetooth format or an 802.11 type format may be used. If the communication is wired, the communication may use Ethernet or any appropriate format. The communication may or may not be encrypted. The application program interfaces (APIs) can take virtually any form. The communication may occur using packets and the packets may contain virtually any data, such as XML data, so long as each presence aware device 200 and additional presence aware device 220 know what to expect from the other resource such that effective communication may occur. The communication may be passive (or one way), rather than active (or two way). In the passive embodiment, the additional presence aware device 220 may detect the beacon signal 230 and the beacon signal may contain sufficient information for the additional presence aware device 220 to begin the data communication experience 210. The beacon signal 210 may only be communicated when the user indicates that the presence aware device 200 should stop the data communication experience 230 or may occur periodically.

At block 415, the additional presence aware device 220 may review the beacon signal 230 for the status indication 240 of the data communication experience 210 from the presence aware device 200. At a high level, the status indication may contain data that may allow the data communication experience 210 on the presence aware device 200 to be closely mimicked and continue on the additional presence aware device 220. The status indication 240 may contain content and/or progress data for the data communication experience 210, for example and not limitation, what song is playing and/or where in a particular song a music experience was when it stopped on the presence aware device 200 or where in a particular download a file was when it stopped on the presence aware device 200.

The status indication 240 may also include environment data for the data communication experience 210. Examples, and not limitations, of the data communication experience 210 environmental data may include volume, surround sound mode, bass level, treble level, etc. if the data communication experience 210 was music. As an example, and not limitation, if the data communication experience 210 is music in a car, the environmental data may include the average noise level in the car and a volume of the stereo (presence aware device 200) in the car. In this way, a similar experience of how loud the music (data communication experience 210) is over the sound of the ambient car noise may be established in the house stereo (the additional presence aware device 220) where the volume of the music likely will be playing with significantly less ambient noise. If the data communication experience was a download, the status indication 240 may include the status of the download. Of course, these are just examples, not limitations.

The status indication 240 may be part of the beacon signal 230. In other embodiments, the status indication 240 is a separate signal. In additional embodiments, the status indication 240 may be a series of signals separate from the beacon signal 230 as often occurs in digital communication. The presence aware device 200 may have a back and forth conversation with the additional presence aware device 220 to determine the capabilities of the presence aware device 200 and the additional presence aware device 220 and to determine the desired setting on the additional presence aware device 220.

At block 420, the status indication 240 of the data communication experience 210 may be stored on the additional presence aware device 220. The status indication 240 may be stored in virtually any memory 152 156, such as a non-volatile memory, a hard disk 141, a flash memory device, etc.

In yet another embodiment, the presence aware device 200 and additional presence aware device 220 are in communication such that a change on the presence aware device 200 is promptly communicated to the additional presence aware device 220 and changes on the additional presence aware device 220 are promptly communicated to the presence aware device 200. In some embodiments, the communicated change may cause the receiving device (either the presence aware device 200 or additional presence aware device 220) to act in response to the communicated change. For example, the additional presence aware device 220 may act as a sort of remote control for the presence aware device 200 and vice versa. In a more specific example, a key on a cell phone (additional presence aware device 200) may be pressed which may cause a car stereo (presence aware device 200) in communication with the cell phone (additional presence aware device 220) to skip ahead a track on a CD in the car stereo (presence aware device 200).

At block 425, if the beacon signal 230 indicates that the data communication experience has been selected to end on the presence aware device 200 several blocks such as blocks 430-435 may be executed. The end beacon signal 230 will likely mean that the user is moving from the presence aware device 200 to the additional presence aware device 220. An example of selecting to end the data communication experience 210 is turning off a car stereo. Another example may be creating default configuration settings that communicates that the data communication experience has been selected to end when certain events occur, such as when a signal is lost. Another example may detect the presence of a user using common presence detection technology and may communicate that the data communication experience has been selected to end when the user is no longer present or when the user enters the presence of the additional presence aware device 220. In some embodiments, the beacon signal 230 may “wake up” or power up the receiving device (presence aware device 200 or the additional presence aware device 220) from a “sleep” or non-active state to an active state. In this way, the device to be activated (presence aware device 200 or additional presence aware device 220) does not have to be in an active state to continue the data communication experience 230. If the devices 200 220 are voice activated, the user may simply announce “switch devices” or uses an input device through the user input interface 160 to achieve the same result. If the beacon signal 230 does not indicate that the data communication experience 210 has been selected to end on the presence aware device 200, the method may repeat.

At block 430, a determination may be made whether the additional presence aware device 220 is data communication experience 210 capable. As the beacon signal 230 may be stored on the additional presence aware device 220, presumably the additional presence aware device 220 should know whether it is data communication experience capable 210. In some embodiments, the additional presence aware device 220 may review the beacon signal when it is received 210 and determine if additional enabling data is needed. For example, if a codec is need for a particular music file (data communication experience 210), the additional presence aware device 220 may use available communication channels to obtain the codec. In another example, if a video file (data communication experience 210) is not present on the additional presence aware device 220, the additional presence aware device 220 may use available communication channels to obtain either the video file (data communication experience 210) or a way to obtain the video file such as from cloud storage, where the video file may be downloaded or streamed. In another embodiment, the user may not wish the data communication experience to continue on the additional presence aware device 220 in the immediate proximity but may wish the additional presence aware device 220 to carry the beacon signal to the next additional presence aware device 220 where the data communication experience 210 may continue. Of course, other embodiments are possible and are contemplated.

An additional determination may be whether the data required to execute the data communication experience is present on the additional presence aware device 220. For example, the data communication experience 210 may be listening on a CD on a car stereo (the presence aware device 200), but a CD cannot be played on a traditional mobile phone (the additional presence aware device 220). Still the user may wish to listen to the music on the CD on the mobile phone. In one embodiment, the mobile phone may have a copy of the data from the CD in a memory, which may be played on the mobile phone. In another embodiment, the mobile phone (the additional presence aware device 220), assuming the proper licenses are present, may attempt to extract the data for the data communication experience 210 from the presence aware device 200.

In yet another embodiment, the additional presence aware device 220 may reach out to other sources for the data to support the data communication experience 210. The other sources may include sources available to the additional presence aware device 220 and may depend on the capabilities of the additional presence aware device 220. For example, if the additional presence aware device 220 has wireless functionality, the additional presence aware device 220 may search wireless for sources of the data. The data may be stored remotely in a cloud like location which may be contacted by the additional presence aware device 220. Assuming that the proper permissions are present, the data may be accessed from the remote location in a streaming fashion or may be downloaded and stored on or streamed to the additional presence aware device 220.

At block 435, the data communication experience 210 on the additional presence aware device 220 using the status indication 240 or the beacon signal 230 may be executed. For example, different additional presence aware devices 220 may have different capabilities and the status indication 240 may be used to match up or adjust capabilities between the presence aware device 200 and the additional presence aware device 220. For example, a car stereo (the presence aware device 200) may have different acoustical properties than a home stereo (the additional presence aware device 220). The car stereo (the presence aware device 200) and home stereo (the additional presence aware device 220) may have a conversation to adjust the volume and equalization such that the music experience (the data communication experience 210) from the car stereo (the presence aware device 200) may be mimicked on the home stereo (the additional presence aware device 220). As a more specific example, a car stereo (the presence aware device 200) may not have a subwoofer while the home stereo (the additional presence aware device 220) may have a subwoofer. The home stereo (the additional presence aware device 220) through the conversation with the car stereo (the presence aware device 200) may determine that the car stereo (the presence aware device 200) did not have a subwoofer so, in response, the home system (the additional presence aware device 220) may reduce the effect of the subwoofer to better match the musical experience that was on the car stereo (the presence aware device 200). In another example, supporting and appropriate additional media content may also be obtained if it is available and desired by the user. More specifically, a car stereo (presence aware device 200) may be able to play a song (data communication experience 210), but when a user enters the house, the home system (additional data communication experience 220) may expand the data communication experience 210 by displaying a video related to the song and playing the song.

In another embodiment, the data communication experience 210 may be optimized for each presence aware device 200 and/or additional presence aware device 220. For example, if the data communication experience 210 is music in the presence aware device 200 in a car, and the data communication experience 210 shifts to an additional presence aware device 220, the data communication experience 210 may be automatically adjusted for the additional presence aware device 220. The adjustment may be set previously, may be selected by the additional presence aware device 220 based on the type of music, may be selected by a user, etc.

The same concept may be applied to virtually any data communication experience 210. For example, if the data communication experience 210 is a game, when moving from a game console (the presence aware device 200) in a car, to a game console (the additional presence aware device 220) in a house, the game may automatically be displayed on the specific game console (the additional presence aware device 220) in the house out of several televisions in the house that has been designated as the game television.

In some embodiments, the data communication experience 210 on the presence aware device 200 may end if the status indication 240 or the beacon signal 230 is successfully communicated. In other embodiment, the data communication experience 210 may end when selected by a user without regard to whether the additional presence aware device 220 has been located or been in communication or if a new additional presence aware device 220 begins communication which has a higher priority based on user preferences or more desirable capabilities.

In other embodiments, the data communication experience 210 may end when the presence of the user ends. In the situation where multiple presence aware devices 200 and/or the additional presence aware devices 220 are present, such as when a portable media player, a cell phone and a car stereo are near a user, the user may select one of the presence aware devices 200 and/or the additional presence aware devices 220 to deliver the data communication experience 210.

In another embodiment, a hierarchy of the presence aware devices 200 and/or the additional presence aware devices 220 may be created to determine which of the presence aware devices 200 and/or the additional presence aware devices 220 that will be the first option to deliver the data communication experience 210, which will be second, etc. In one embodiment, relevant factors are used to decide when to switch devices such as the relative power level of the presence aware devices 200 and/or the additional presence aware devices 220, the relative signal strengths, the relative communication signal quality, previous selections by a user, etc.

If the determination at block 430 is false, then control proceeds to block 440, where the method may be repeated, for example by substituting the additional presence aware device 220 for the presence aware device 200 and starting again at block 400. Referring to FIG. 3, in this way, the additional presence aware device 220 will become the distributor of the beacon signal 230 as the presence aware device 200. For example, the additional presence aware device 220 may simply be a device (a cell phone from FIG. 2) to carry the beacon signal 230 or the status indication 240 as the presence aware device 200 to yet another additional presence aware device 220 (house). FIG. 3 may be an example of such a situation in that a traditional mobile phone usually is not media enabled. The mobile phone may receive the beacon signal 230 or the status indication 240 but not be able to execute the data communication experience 210 such as play a video or a song. The “new” presence aware device 200 (the cell phone) will wait until communication is made with another additional presence aware device 220 (home stereo) and the method may continue. From the previous example, the traditional cell phone may carry the beacon signal 230 or the status indication 240 from a car stereo to a home stereo but the traditional mobile phone may never execute the data communication experience 210. The beacon signal 230 or status indication 240 may be passed through numerous devices (the presence aware device 200 and/or additional presence aware device 220) until a capable device and recognized device (the presence aware device 200 and/or the additional presence aware device 220) is located.

The method addresses the problem of how to continue the data communication experience 210 when a user moves from the presence of the presence aware device 200 to the additional presence aware device 220. The result of the method is that users can actually seamlessly continue the data communication experience 210 when a user moves from the presence of the presence aware device 200 into a presence of the additional presence aware device 220, thereby saving user time, processor use in search for the same data experience on multiple devices, adding convenience of usage of media devices, etc.

In conclusion, the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

1. A method of providing a seamless data communication experience across a presence aware device and an additional presence aware device comprising:
determining if a beacon signal has been received;
determining if the beacon signal is recognized;
if the beacon signal is recognized, establishing communication between the presence aware device and the additional presence aware device;
reviewing on the additional presence aware device the beacon signal for a status indication of the data communication experience from the presence aware device;
if a status indication is present, storing the status indication of the data communication experience on the additional presence aware device;
if the beacon signal indicates that the data communication experience has been selected to end on the presence aware device;
if additional presence aware device is data communication experience capable:
executing the data communication experience on the additional presence aware device using the status indication;
if the additional presence aware device is not data communication experience capable:
repeating the method, substituting the additional presence aware device for the presence aware device.

2. The method of claim 1, further comprising ending the data communication experience on the presence aware device if the status indication is successfully communicated and an indication is received that the data communication experience is to end on the presence aware device.

3. The method of claim 1, further comprising providing a user with an opportunity to select an option to automatically terminate a current experience when the user exits a sphere of the presence aware device.

4. The method of claim 1, further comprising allowing one of a plurality of additional presence aware devices to be selected to continue the data communication experience.

5. The method of claim 1, further comprising on the additional presence aware device, periodically searching for the beacon signal.

6. The method of claim 1, further comprising on the additional presence aware device, periodically communicating the beacon signal.

7. The method of claim 1, wherein the status indication comprises progress data or content for the data communication experience.

8. The method of claim 1, wherein the status indication comprises environment data for the data communication experience.

9. The method of claim 8, wherein the environmental data further comprises volume data.

10. The method of claim 1, further comprising using the environmental data to mimic the data communication experience from the presence aware device on the additional presence aware device.

10. The method of claim 1, wherein the presence aware device and additional presence aware device comprise a processor for executing computer executable code and an input/output circuit.

12. The method of claim 11, further comprising communicating the beacon signal through wireless communication.

13. The method of claim 1, wherein the data communication experience comprises at least one selected from a group consisting of:
an audio experience;
a video experience;
a game experience;
an audio/visual experience;
an internet experience; and
a download experience.

14. The method of claim 1, wherein the status indication is part of the beacon signal.

15. A computing device comprising a processor physically configured in accordance with computer executable instructions, a memory for storing the computer executable instructions and an input output circuit, the computer executable instructions comprising instructions for providing a seamless data communication experience across a presence aware device and an additional presence aware device, the computer instructions comprising instructions for:
determining if a beacon signal has been received;
determining if the beacon signal is recognized;
if the beacon signal is recognized, establishing communication between the presence aware device and the additional presence aware device;
reviewing on the additional presence aware device the beacon signal for a status indication of the data communication experience from the presence aware device wherein the data communication experience may be selected;
if a status indication is present, storing the status indication of the data communication experience on the additional presence aware device;
if the beacon signal indicates that the data communication experience has been selected to end on the presence aware device;
ending the data communication experience on the presence aware device if the status indication is successfully communicated;
if additional presence aware device is data communication experience capable:
executing the data communication experience on the additional presence aware device using the status indication;
if the additional presence aware device is not data communication experience capable:
repeating the method, substituting the additional presence aware device for the presence aware device.

16. The computing device of claim 15, further comprising on the additional presence aware device, periodically searching for the beacon signal.

17. The computing device of claim 15, further comprising on the additional presence aware device, periodically communicating the beacon signal.

18. The computing device of claim 15, wherein the beacon signal further comprises a status indication and wherein the status indication further comprises at least one selected from a group comprising:
progress data for the data communication experience;
content data for the data communication experience; or
environment data for the data communication experience.

19. The computing device of claim 15, further comprising communicating the beacon signal through wireless communication.

20. The computing device of claim 15, wherein the data communication experience is one selected from a group comprising:
an audio experience;
a video experience;
a game experience;
an internet experience;
an audio/visual experience; and
a download experience.
